(19) United States
(12) Patent Application Publication
(10) Pub. No.: US 2004/0200265 A1
(43) Pub. Date: Oct. 14, 2004

(54) Vehicle particulate analysis method and apparatus

(76) Inventors: Gideon Eden, Ann Arbor, MI (US); Susan Rauschl, Chelsea, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/492,645

(22) PCT Filed: Oct. 21, 2002
(86) PCT No.: PCT/US02/33605

Related U.S. Application Data
(60) Provisional application No. 60/344,721, filed on Oct. 22, 2001.

(51) Int. Cl. G01N 31/00

(52) U.S. Cl. 73/23.31; 702/24; 73/28.01

(57) ABSTRACT

A method and apparatus for characterizing particulate matter in gases emitted from the exhaust tailpipe of a moving vehicle includes providing a micro-dilution device on the vehicle and, while the vehicle is moving, retrieving samples of the gases and mixing the samples with ambient air with the micro-dilution device, thereby forming diluted samples of the gases containing volatile and non-volatile particulate matter. A particulate analyzer is provided on the vehicle which measures at least one parameter of the volatile and non-volatile particulate matter.

### CROSS REFERENCE TO RELATED APPLICATIONS

This application claims priority from U.S. provisional patent application Ser. No. 60/344,721, filed on Oct. 22, 2001, the disclosure of which is hereby incorporated herein by reference in its entirety.

### BACKGROUND OF INVENTION

The present invention relates to characterizing gases emitted from a vehicle exhaust tailpipe and, in particular, to characterizing particulate matter in the gases.

It is desirable to characterize particulate matter and gases emitted from the exhaust tailpipe of a vehicle. This is particularly true of vehicles propelled by a pressure ignition engine, such as a diesel engine. However, vehicles propelled by a spark ignition engine also can develop particulate matter in gases emitted from the exhaust tailpipe. One difficulty with characterizing such particulate matter is that not all of the particulate matter is formed while the exhaust, gases are contained in the exhaust tailpipe. Some of the particulate matter is formed upon contact with ambient air surrounding the vehicle. Accordingly, in order to obtain an accurate characterization of the particulate matter and gases emitted from the exhaust tailpipe of the vehicle, it is necessary to combine ambient air with the exhaust prior to analyzing the particulate matter.

### SUMMARY OF INVENTION

The present invention provides a unique technique for diluting gases emitted from exhaust tailpipes with ambient air. In particular, the present invention provides such a technique that may be used with a moving vehicle. In this manner, particulate matter can be characterized during various operating conditions of the vehicle on an ongoing basis.

An apparatus for characterizing particulate matter in gases emitted from the exhaust tailpipe of a moving vehicle, according to an aspect of the invention, includes a micro-dilution device that is adapted to be on a moving vehicle and a particulate analyzer that is also adapted to be on the moving vehicle. The micro-dilution device retrieves samples of the gases and mixes the samples with ambient air, thereby forming diluted samples of the gases containing volatile and non-volatile particles. A method and apparatus for the particulate analyzer retrieves the diluted samples from the micro-dilution device and measures at least one parameter of the particulate matter.

The micro-dilution device may include an ambient air mass flow controller controlling flow of ambient air and/or a gas mass flow controller controlling flow of the gases. Either of the ambient air or gas mass controllers may be variable. The micro-dilution device may be configured to be mounted in proximity to a vehicle tailpipe. The micro-dilution device may retrieve samples through a linking line comprising a pipe linked to the exhaust tailpipe, which may be heated in order to reduce loss of particulate matter In the linking line. The linking line may be heated to temperatures within the range of 50 to 200 degrees centigrade.

The particulate analyzer may be a particulate counter capable of assessing a number of particles in the gas. The particulate counter may comprise a light source, such as a laser, and a photodetector, such as a photo diode. The particulate analyzer may comprise a sound (sonic or ultrasonic) wave generator and a corresponding sound detector. The particulate analyzer may comprise a charging device providing electrical charge to the particles and an electrometer. The particulate analyzer may comprise a Condensation Nucleus Counter (CNC). The particulate analyzer may comprise an Incandescent Particle Counter (IPC). The particulate analyzer may measure the mass of the particulate matter. The particulate analyzer may be a vibrating substrate accumulating the particulate matter, wherein changes of vibration parameters of the substrate are indicative of the mass change of the substrate due to the accumulation of the particulate matter. In such case, the parameter may be a resonant frequency of the substrate and/or a vibration amplitude of the substrate. The particulate analyzer may also measure the shape of particles in specific size ranges.

The invention may be used with a vehicle propelled by a pressure ignition engine or a spark ignition engine.

The at least one parameter may include count of the particles present in the particulate matter by particle size histogram entailing specific particle size groups. The method and apparatus may include providing a mass analyzer, measuring the mass of the particulate matter and resolving the resulting measured mass and particle to estimates of the mass of the particles according to size as defined by the size histogram. The mass analyzer may be on the moving vehicle or separate from the vehicle.

An apparatus and method for measuring and characterizing particulate matter emitted from an engine, according to another aspect of the invention, includes providing a mass analyzer, a particle analyzer and a computer. The mass analyzer measures the mass of the particulate matter. The particle analyzer counts the particles present in the particulate matter by particle size histogram entailing specific particle size groups. The computer resolves the resulting measured mass and particle counts to estimates of the mass of the particles according to their size as defined by the size histogram.

The mass measurement of the particulate matter may utilize gravimetric measurement of the particulate matter trapped in a filtering substrate placed in the stream of gases emitted from the engine. The gravimetric measurement may consist of weighing the filtering substrate using an analytical balance. Alternatively, the filtering substrate may be held in a vibrating holder driven by an oscillator driver that is capable of measuring changes of the resonant frequency of the combination of the filtering substrate, the vibrating holder and the particulate matter trapped in the filtering substrate. Alternatively, the filtering substrate may be held by a vibrating holder driven by an oscillator driver that is capable of measuring changes of the oscillating amplitude of the vibrating holder at specific oscillating frequency.

The mass measurement of the particulate matter may include trapping of the particles on the surface of a vibrating quartz crystal substrate, forming the frequency controlling component of a tuned oscillator, and measuring changes in resonant frequency of the substrate resulting from accumulation of the particulate matter upon its surface. Alternatively, the mass measurement of the particulate matter may include trapping the particles on the surface of a vibrating quartz substrate and measuring changes of the oscillating amplitude of the substrate resulting from accumulation of the particulate matter upon its surface. The particles may be trapped upon the surface of the substrate by maintaining electrostatic attracting force between the particles and the quartz substrate. The particles may be electrically charged by an ultraviolet lamp or utilizing a corona generator. The quartz substrate may be electrically charged by connecting a voltage source between the quartz substrate and a reference point, thereby generating electric field in the vicinity of the quartz substrate. The electrostatic force may result from a combination of these techniques.

The counting may be carried out by passing electromagnetic energy through the stream of the gas emitted by the engine and simultaneously sensing the energy variations resulting from the interaction of the electromagnetic energy with the particles. The electromagnetic energy may be generated by a laser or an ultraviolet lamp. The energy variations may be sensed by an optical detector.

The counting may include charging the particles with electrical charges, wherein the magnitude of the electrical charges are directly related to the size and concentration of the particles and further including selective measurement of the resulting electrical charge of each size of the particles using an electrometer. The charging may be performed by an ultraviolet lamp or a corona generator.

The technique may be used for measuring and characterizing the particulate matter of pressure-ignited engines or spark-ignited engines.

These and other objects, advantages and features of this invention will become apparent upon review of the following specification in conjunction with the drawings.

### BRIEF DESCRIPTION OF DRAWINGS

FIG. 1 is a side elevation of a vehicle equipped with an apparatus for characterizing particulate matter emitted from the exhaust tailpipe of the vehicle, according to the invention;

FIG. 2 is a perspective view of an apparatus for characterizing particulate matter emitted from the exhaust tailpipe of a moving vehicle, according to the invention;

FIG. 3 is a block diagram of the apparatus in FIG. 2;

FIG. 4 is a diagram of a micro-dilution device, according to the invention;

FIG. 5 is the same view of FIG. 4 of an alternative embodiment thereof;

FIG. 6 is a diagram of a particulate analyzer useful with the invention;

FIG. 7 is a diagram illustrating the operation of the particle analyzer in FIG. 6;

FIG. 8 is a plot of an output of the apparatus in FIG. 2 over a period of time;

FIG. 9 is the same view as FIG. 3 of an alternative embodiment thereof;

FIG. 10 is a flowchart of a particle mass measuring technique by particle size; and

FIG. 11 is a table of a characterization of particulate matter obtained by the apparatus herein.

### DESCRIPTION OF THE PREFERRED EMBODIMENT

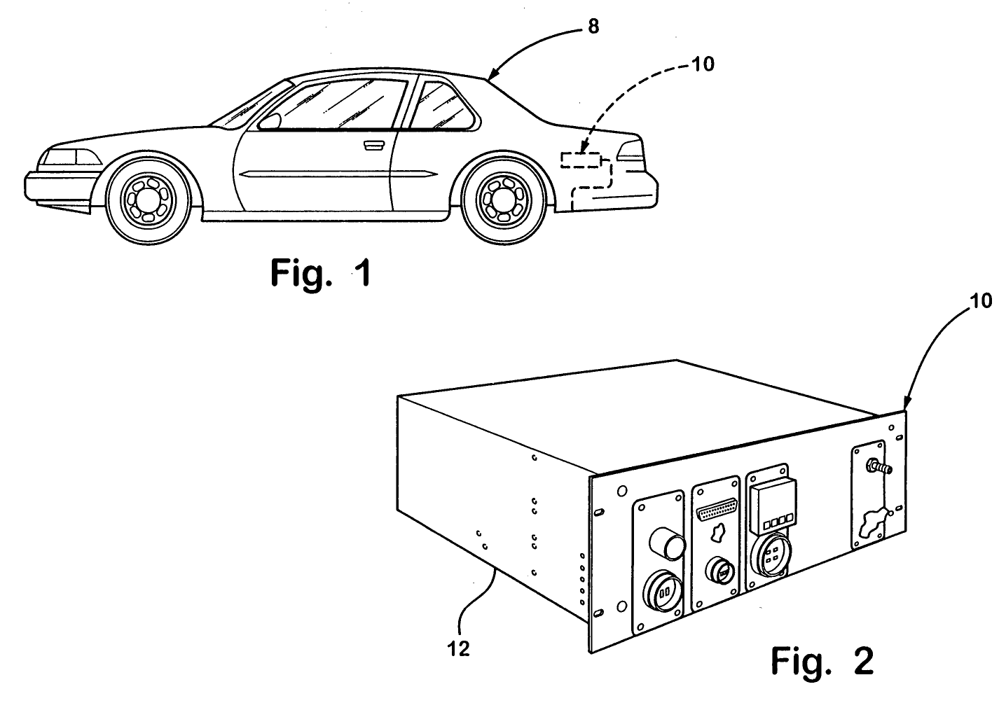

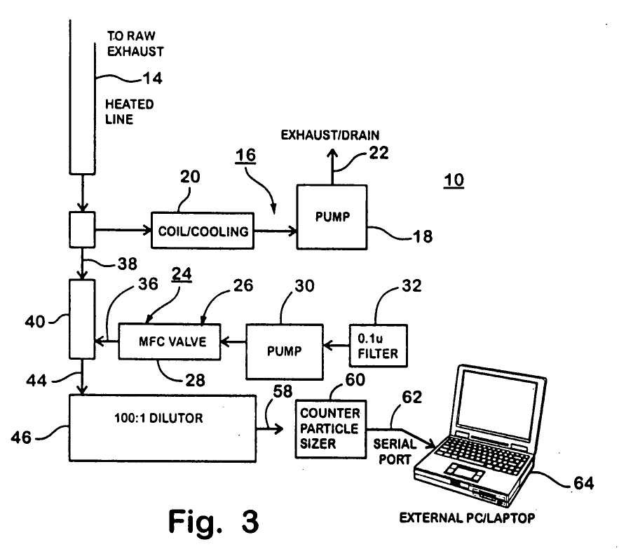

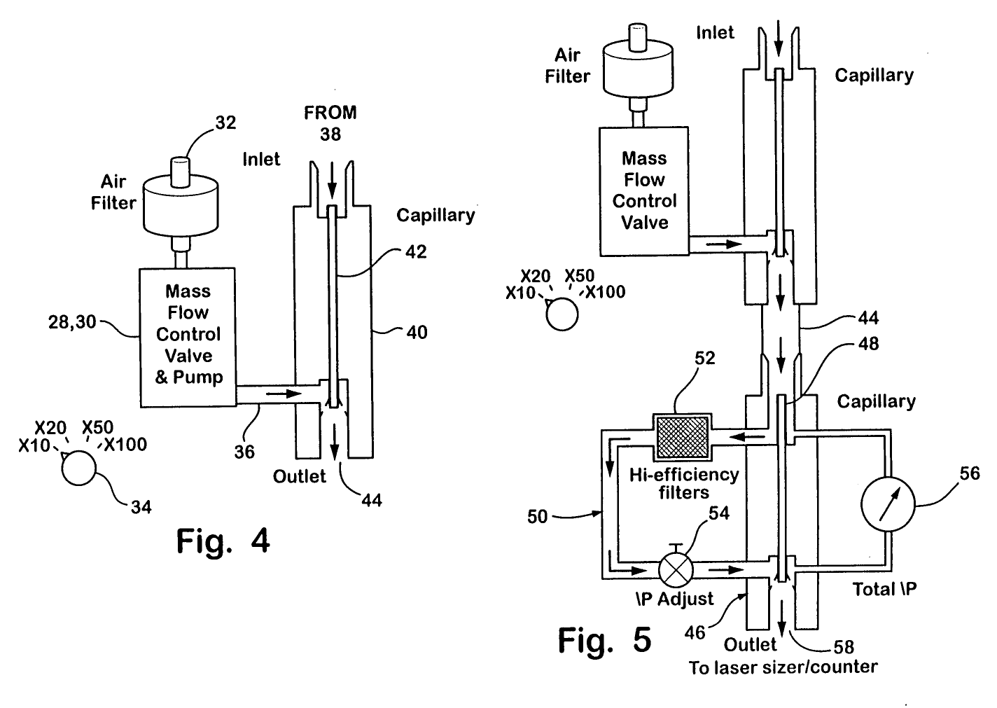

Referring now to the drawings and the illustrative embodiments depicted therein, an apparatus 10 is for characterizing particulate matter in gases emitted from an exhaust tailpipe of a moving vehicle 8 (FIG. 1). Vehicle 8 may be propelled by a compression-ignition engine which has traditionally been associated with particulate matter emission. However, vehicle 8 may be propelled with a spark-ignition engine which also may be capable of producing particulate matter emission. Apparatus 1 0 includes a housing 12 incorporating the components thereof, which is adapted to be positioned on the vehicle. In the illustrative embodiment, apparatus 10 may be positioned in the trunk of the vehicle, and powered by the vehicle's battery. Alternatively, apparatus 10 may be mounted in a housing of the type disclosed in commonly assigned U.S. patent application Ser. No. 09/911,836, filed Jul. 24, 2001, by Andrew Reading et al. entitled VEHICLE GAS EMISSION SAMPLING AND ANALYSIS ASSEMBLY, the disclosure of which is hereby incorporated herein by reference. In this manner, the apparatus could be positioned on other portions of the vehicle besides the trunk.

Apparatus 10 includes a line 14 for retrieving samples from the vehicle tailpipe. In order to reduce loss of particulate matter in the linking line, the linking line may be heated. In the illustrative embodiment, the line may be heated to temperatures within a range of 50 to 200 degrees centigrade, although temperatures outside of this range may be selected. The line may be non-heated if short enough or if other means are provided to reduce loss of particulate matter. An exhaust discharge assembly 16 may be provided in order to discharge the majority of the exhaust gas retrieved by line 14. The purpose of the exhaust discharge 16 is in order to facilitate a large flow of volume through line 14. This reduces the latency between the measurements made by apparatus 10 because it allows a high volume flow through line 14, as would be understood by the skilled artisan. Exhaust discharge 16 includes a discharge pump 18, such as a 5-liter per minute pump and a cooling unit 20 which cools the exhaust gas being pumped by pump 18 to an exhaust drain 22. If latency is not an issue, exhaust discharge 16 may be eliminated.

The portion of the exhaust gas retrieved by line 14 that is not discharged by exhaust discharge assembly 16 is supplied to a micro-dilution device 24. Micro-dilution device 24 includes a Mass Flow Controller (MFC) 26. Mass flow controller 26 includes a mass flow control 28, an ambient air pump 30 and a particle filter 32. Mass flow control 28 includes an internal feedback loop, which provides for a controlled mass flow irrespective of variations in the output of pump 30. To reduce condensation, mass flow controller 26 is heated. The mass flow rate of mass flow control 28, in the illustrative embodiment, provides for adjustable mass flow. It may be adjusted mechanically by a mechanical adjuster 34 or it may be control led by software. The mass flow control is commercially available from multiple sources, such as a Model 810 mass flow controller marketed by Sierra of Monterey, Calif. Air pump 30 is, in the illustrative embodiment, a 15-psi pump, which has an input that is filtered by filter 32, which is a 0.1-micron filter.

An output 36 of mass flow controller 26 is combined with the exhaust gas line 38 at a combiner 40. Combiner 40 includes a capillary 42, which combines a portion of output 36 with the exhaust gas from line 38. An outlet 44 of combiner 40 may be further diluted by a diluter 46, as illustrated in FIG. 5. Diluter 46 includes a capillary 48 and a bypass branch 50, which bypasses capillary 48. Bypass branch 50 includes a high efficiency, such as hepa, filter 52 and an adjustable restriction 54. Because the particulate matter in bypass branch 50 is filtered by filter 52, the amount of mass passing through bypass 50 dilutes the particulate content of the gas from output 44. In the illustrative embodiment, diluter 46 provides a 100:1 dilution ratio. However, any dilution ratio may be selected and, indeed, diluter 46 may not be required in all applications. A pressure gauge 56 may be provided to monitor the condition of the diluter.

An outlet 58 of diluter 46 is supplied to a particle analyzer, such as a counter, and particle sizer 60. Particle analyzer 60 determines a parameter related to the particle content of the raw exhaust provided from line 14. Particle analyzer 60 may measure the count of the particles present in the particulate matter by a size histogram entailing specific particle size groups and provide the histogram through a serial port 62 to a logging device, such as a computer 64.

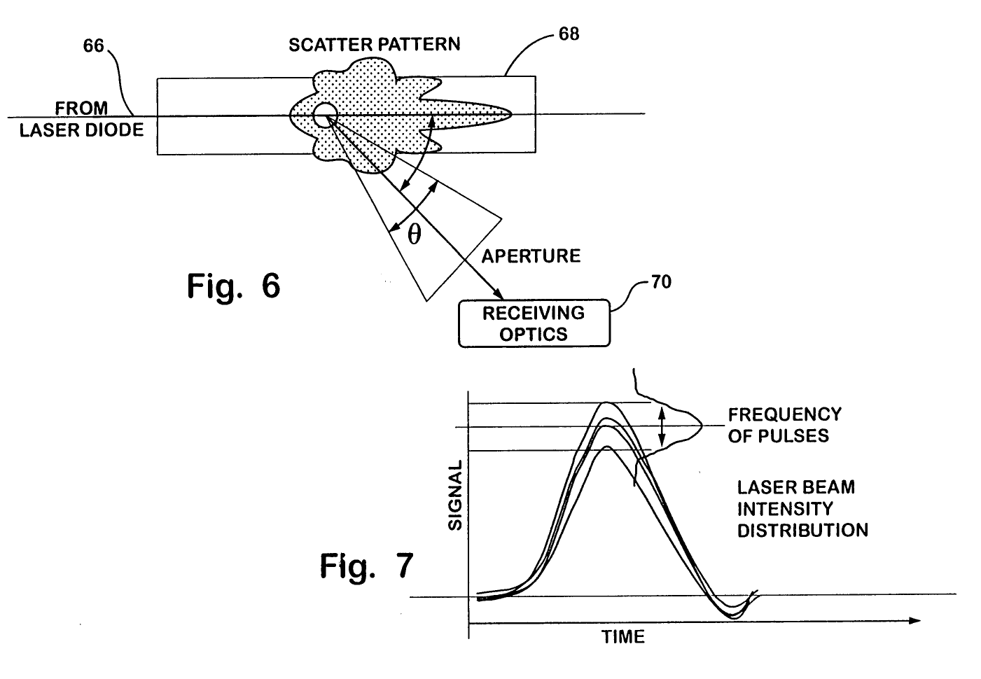

Particle counter and sizer 60 may be accomplished by any one of a number of known techniques. One technique, known as laser beam scattering, is illustrated in FIGS. 6 and 7. A beam 66 from a laser dial (not shown) is supplied to a sample chamber 68, which contains the diluted gas sample from the exhaust. Laser beam 66 is scattered by the presence of particles, which is detected by receiving optics 70. Receiving optics 70 may include a photo-detector, which produces an output as illustrated in FIG. 7. Referring now to FIG. 7, the output of receiving optic 70 is illustrated as a series of pulses of varying amplitude. The various levels of amplitude of the laser beam intensity distribution represent the presence of particles of various sizes. The frequency of the existence of the laser beam pulse at a particular amplitude indicates the count of the particles at the corresponding particle size. Thus, a particle size histogram may be obtained providing specific particle size group concentration.

It should be understood that the technique illustrated in FIGS. 6 and 7 are but one of many possible techniques used to analyze the diluted exhaust gas. An example of such a system is supplied by Particle Measuring Systems, Inc. under the Lasair II Aerosol Particle Counter. Another technique utilizes a natural oscillating frequency of a tapered element as an additional mass of particles collects on a filter. Such technique is commercially available from Rupprecht and Patishnick Co., Inc. under Model No. TEOM Serial No. 1105 Diesel Particulate Monitor.

Another example of a particle analyzer that may be used with apparatus 10 utilizing Laser-induced Incandescence (LII), also known as Incandescent Particle Counter (IPC). An example of such a system is supplied by Artium Technologies, Inc. Another type of a particle analyzer operates on the basis of a charging device providing electrical charge to the particles and at least one electrometer capable of measuring the charge of the particles after the particles are charged by the charging device. An example of such a device is marketed by Dekati under the Dekati Mass Monitor DMM-230 brand.

Another type of particle analyzer utilizes a photonic wave generator and an acoustic detector. Such a type of system is marketed by Mari under Model No. RPM-100. Another type of particle analyzer includes a Condensation Nucleus Counter (CNC or CPC). An example of such a system is commercially available from TSI under type 3760A. Another device manufactured by Matter Engineering A.G. under type LQ1-DC is operated by a diffusion particle charging particle sensor.

Apparatus 10 operates as follows. Exhaust gas received from line 14 is reduced in volume by exhaust discharge 16 and is supplied through exhaust gas inlet 38 to combiner 40, which dilutes the exhaust gas, by ambient air supplied by pump 30. The ambient air is supplied at a controlled rate by mass flow control 28 and is combined with a controlled flow of exhaust gas through combiner 40. The particle density may be diluted by diluter 46 and supplied by outlet 58 to particle analyzer 60 where the size histogram is determined. The histogram is supplied by serial port 62 to computer 64. Computer 64 makes a repetitive determination of the count of particles of various sizes as obtained on serial port 62. Alternatively, serial port 62 may include an analog or digital output of particle analyzer 60 and computer 64 may conduct the particle count from the serial port data. Should the particle count displayed by computer 64 either saturate the particle analyzer 60 or be too low to be accurately read, then the value of mass flow control 28 may be adjusted by adjusting adjuster 34. As illustrated in FIG. 4, adjuster 34 may produce various increments of dilution of the exhaust gas.

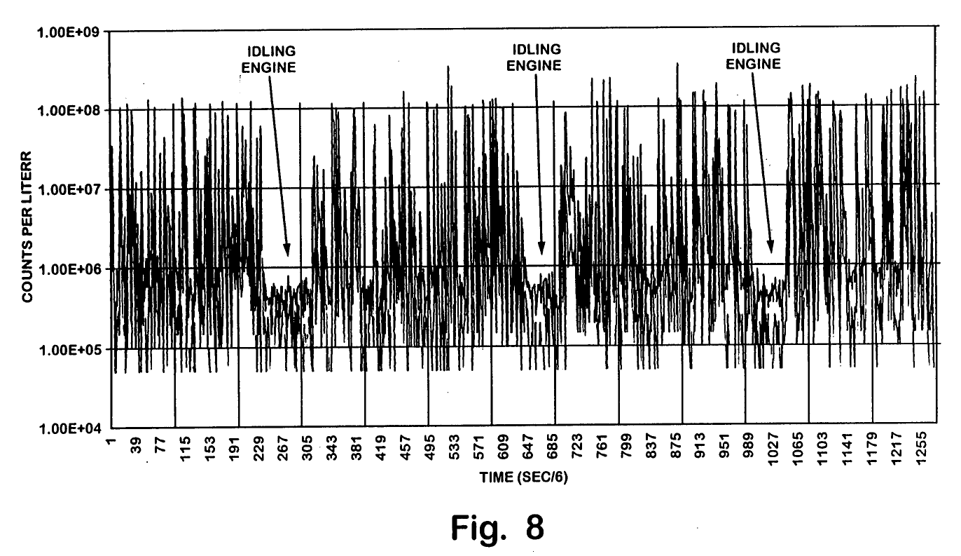

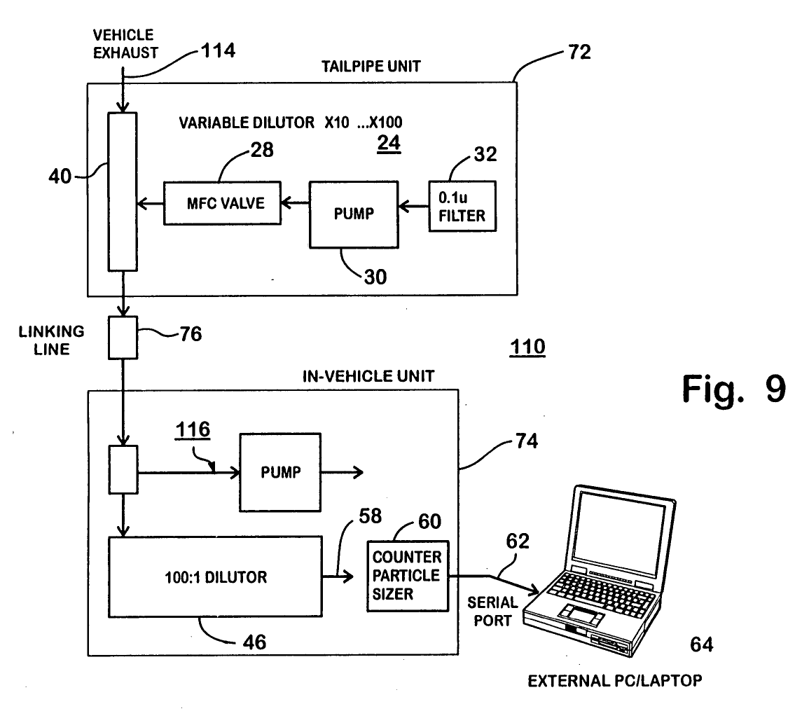

Apparatus 10 may, advantageously, be located a distance from the vehicle exhaust tailpipe. An alternative analyzer 110 is illustrated in FIG. 9 which is configured to be mounted, at least in part, in proximity to the vehicle tailpipe thereby enabling immediate mixing of the gases with ambient air. Apparatus 110 includes a tailpipe unit 72, which is mounted in close proximity to the vehicle tailpipe, and an in-vehicle unit 74 which may be mounted away from the vehicle tailpipe. Tailpipe unit 72 includes micro-dilution device 24, namely, mass flow control valve 28, pump 30, filter 32 and combiner 40. Because the tailpipe unit may be positioned in proximity to the tailpipe, it may be connected to the tailpipe with a line 1 14, which does not have to be heated. A linking line 76, which also does not need to be heated because it is conveying diluted exhaust gas, is reduced in volume by an exhaust discharge 116 and supplied to an optional diluter 46. As with analyzer 10, outlet 58 of diluter 46 is supplied to particle analyzer 60 whose output serial port 62 is supplied to computer 64. Apparatus 10, 110 may provide particle count data of the type illustrated in FIG. 8, which was collected on a diesel bus, byway of example. Referring to FIG. 8, it can be seen that the particulate count is lower during periods where the engine is idling and is higher during other periods. However, it can be seen that the apparatus 10, 110 provides an ongoing stream of data for the vehicle, which it is moving rather than placed on a dynamometer or merely in,an idling state.

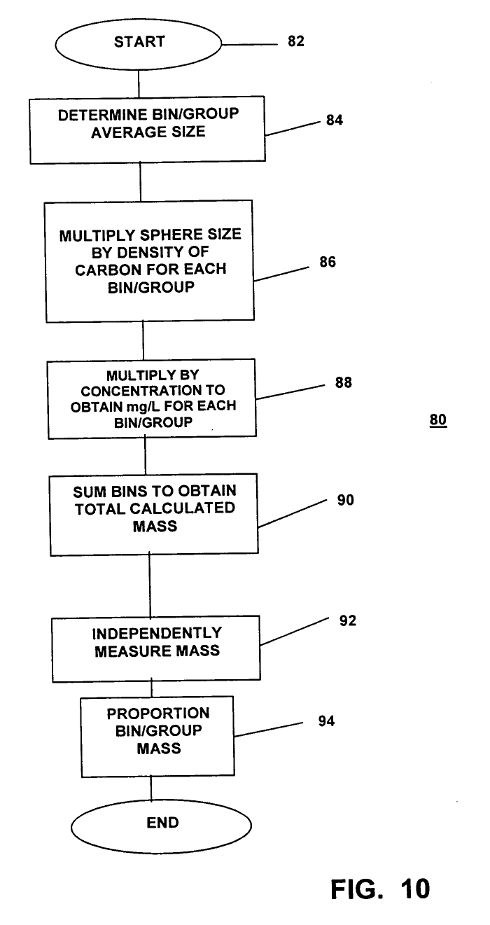

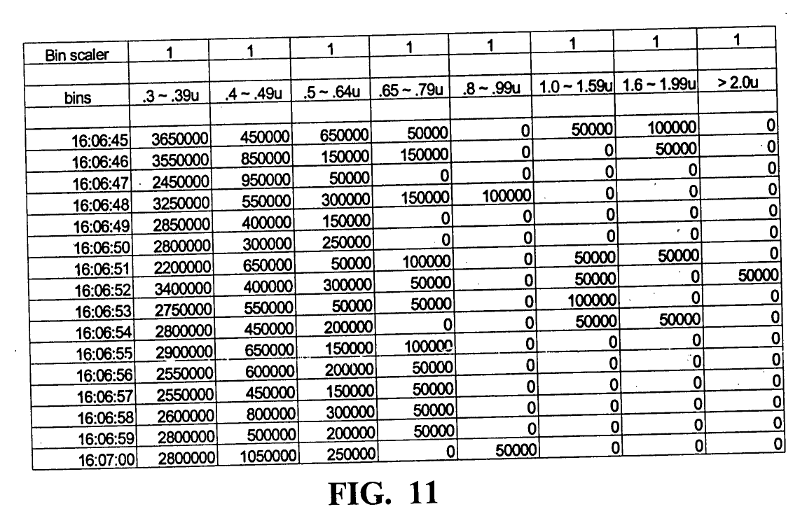

In addition to determining a count of the particles present in the particulate matter by particulate size histogram entailing specific particle size groups, it may be desirable to at least estimate the mass of the particles according to size as defined by the size histogram. This may be accomplished by resolving an independently measured mass and the particle count according to a mass measuring technique 80 (FIG. 10). Technique 80 begins at 82 and then a determination is made at 84 of the average particle size for the particles in each bin and group. A sphere size is calculated for each sphere diameter and is multiplied by the density of the compound, which is the primary constituent of the particulate, for each bin or group. This result is multiplied by the concentration of each bin/group in order to obtain the micrograms per liter for each bin or group at 88. The masses of all of the bins are summed at 90 in order to obtain a total calculated mass. Mass of the particulate is measured at 92 utilizing known mass measuring techniques. The total mass calculated at 90 is compared with the mass independently measured at 92 and the bin/group mass is adjusted at 94 according to the ratio of calculated mass to independently measured mass. Further refinement of the calculated mass can be obtained by measuring the shape associated with each particulate bin, as indicated for example by an optical detector manufactured by Thermo Oriel inc.

Various techniques may be utilized to independently measure mass. This may include utilizing gravimetric measurement of the particulate matter trapped in a filtering substance placed in the stream of gas emitted from the engine. The gravimetric measurement may be accomplished by weighing the filtering substrate using an analytical balance. Alternatively, the filter substrate may be held in a vibrating holder driven by an oscillator driver that is capable of measuring changes of the resonant frequency of the combination of the filtering substrate, the vibrating holder and the particulate matter trapped in the filtering substrate. Alternatively, the filtering substrate may be held by a vibrating holder driven by an oscillator driver that is capable of measuring changes of the oscillating amplitude of the vibrating holder at specific oscillating frequencies.

In operation, the sample to be analyzed is pumped through the heated line at a flow, such as 4 to 5 liters per minute (LPM), to minimize transport time. When it reaches the instrument, most of the sample is “scavenged” or vented through exhaust discharge assembly 16. Only a small remaining fraction of the sample is actually used for analysis. This fractional part of the raw exhaust is delivered to micro-dilution device 24, which is maintained above dew point to prevent condensation.

The micro-dilution device is a mixing chamber that allows the raw exhaust fraction to be combined with a predetermined amount of clean air. A mass flow controller is used to deliver the particle-reduced air to the mixing chamber. Four (4) mass flow settings may be provided to establish fixed dilution ratios (10:1, 20:1, 50:1, and 100:1). For example, a 10:1 dilution ratio is achieved when 0.9 LPM of particle-free air is mixed with 0.1 LPM raw exhaust (assuming total flow of 1 LPM). The micro-dilution device also reduces the temperature of the raw exhaust fraction and lowers dew point such that water condensation does not occur.

The first diluted sample is then delivered to second fixed dilutor having a 100:1 dilution ratio. This provides total sample dilution of 1000:1, 2000:1, 5000:1, or 10,000:1 for the light-scattering Particulate Counter. These theoretical dilution ratios may be adjusted by the Host Program in order to accommodate variations resulting from the various particulate sizes. The light-scattering technology provides discrete particle counts using a semiconductor-laser as the light source. The diluted exhaust sample is drawn into this optical bench via an internal volume-controlled pump at a rate of 1.2 liters/minute. The sample passes through the sample cell, past the laser diode detector and is collected onto a 47-mm PTFE filter, where the sample collected on the PTFE filter can be chemically analyzed.

The bench internal pump also generates clean sheath air, which is filtered and passes through the sheath air regulator back to the optical chamber. This is to ensure that no dust contamination comes in contact with the laser-optic assembly. This particle-free airflow is also used for the reference-zero test during the bench auto-calibration process. During exhaust sampling, the scattered signal caused by particles passing through the laser beam, is collected at 90 degrees by a mirror and transferred to a photo diode. The signal from the diode is analyzed by a multi-channel size classifier. Each particle passing the laser beam generates a pulse whose height is proportional to the particle's size.

Software automatically sets the total dilution factor and applies it to the data particle-counts based on the chosen first stage dilution. The laser light-scattering counter outputs “particle-size versus number of particles” data to the Host Program through an RS-232 data link. Real-time data is displayed graphically on the computer screen and is stored as comma-separated values in a data file.

Other mass measuring techniques may be utilized. The mass measuring of the particulate matter may include trapping the particles on the surface of a vibrating quartz crystal substrate forming the frequent controlling component of a tuned oscillator and measuring changes in resonant frequency of the quartz substrate resulting from accumulation of the particulate matter upon its surface. Alternatively, the mass measurement of the particulate matter may include trapping the particles on the surface of a vibrating quartz substrate and measuring changes of the oscillating amplitude of the substrate resulting from accumulation of the particulate matter upon the surface. The particles may be trapped upon the surface of the substrate by maintaining electrostatic attracting force between the particles and the quartz substrates. The particles may be electrically charged by an ultraviolet lamp or utilizing a corona generator. The quartz substrate may be electrically charged by connecting a voltage source between the quartz substrate and a reference point, thereby generating electric field in the vicinity of the quartz substrate. An electrostatic force may result from a combination of these techniques.

The determination of the particle count for each bin/group may be carried out in manners previously described herein, such as by apparatus 10. While the particle count per bin/group may be obtained while the vehicle is moving, determination of the mass of each bin or group may be obtained either on the vehicle or off the vehicle.

Changes and modifications in the specifically described embodiments can be carried out without departing from the principles of the invention which is intended to be limited only by the scope of the appended claims, as interpreted according to the principles of patent law including the Doctrine of Equivalents.

1. An apparatus for characterizing particulate matter in gases emitted from the exhaust tailpipe of a moving vehicle, comprising:
micro-dilution device adapted to be on a moving vehicle, said micro-dilution device retrieving samples of the gases and mixing said samples with ambient air, thereby forming diluted samples of the gases containing volatile and non-volatile particulate matter; and
particulate analyzer adapted to be on the moving vehicle, said particulate analyzer retrieving a partial gas volume of said diluted samples and measuring at least one parameter of the particulate matter.

2. The apparatus of claim 1 wherein said micro-dilution device comprises an ambient air mass flow controller controlling the flow of said ambient air.

3. The apparatus of claim 1 wherein said micro-dilution device comprises a gas mass flow controller controlling the flow of said gases.

4. The apparatus of claim 3 wherein said micro-dilution device further comprises an ambient air mass flow controller controlling the flow of said ambient air.

5. The apparatus of claim 4 wherein at least one said ambient air mass flow controller and said gas mass flow controller provides adjustable levels of mass flow.

6. The apparatus of claim 1 wherein said micro-dilution device is configured to be mounted in proximity to a vehicle tailpipe, enabling immediate mixing of the gases with the ambient air.

7. The apparatus of claim 1 wherein said micro-dilution device retrieves said samples through a linking line comprising a pipe linked to the exhaust tailpipe.

8. The apparatus of claim 7 wherein said linking line is heated in order to reduce loss of the particulate matter in said linking line.

9. The apparatus of claim 8 wherein said linking line is heated to temperatures within the range of 50 to 200 degrees centigrade.

10. The apparatus of claim 1 wherein said particulate analyzer is a particulate counter capable of assessing a number of particles in the gases.

11. The apparatus of claim 1 wherein said particulate counter comprises at least one light source and at least one photodetector.

12. The apparatus of claim 11 wherein said particulate light source is a laser.

13. The apparatus of claim 11 wherein said light source is an ultraviolet lamp.

14. The apparatus of claim 1 wherein said particulate analyzer comprises an electromagnetic wave generator and an acoustic detector.

15. The apparatus of claim 1 wherein said particulate analyzer comprises a charging device providing electrical charge to said particles and an electrometer capable of measuring the charge of said particles after said particles are charged by said charging device.

16. The apparatus of claim 1 wherein said particulate analyzer comprises a Condensation Nucleus Counter (CNC).

17. The apparatus of claim 1 wherein said particulate analyzer comprises an Incandescent Particle Counter (IPC).

18. The apparatus of claim 1 wherein said particulate analyzer measures the mass of the particulate matter.

19. The apparatus of claim 1 wherein said particulate analyzer comprises a vibrating substrate accumulating the particulate matter, wherein changes of vibrating parameters of said substrate are indicative of the mass change of said substrate due to the accumulation of the particulate matter.

20. The apparatus of claim 19 wherein said parameter is the resonance frequency of said substrate.

21. The apparatus of claim 19 wherein said parameter is the vibration amplitude of said substrate.

22. The apparatus of claim 19 wherein said substrate is chosen from at least one of a quartz and a paper filter.

23. The apparatus of claim 1 operable with a vehicle propelled by a pressure ignition engine.

24. The apparatus of claim 1 operable with a vehicle propelled by a spark ignition engine.

25. The apparatus of claim 1 wherein said at least one parameter includes a count of the particles present in the particulate matter by particular size histogram entailing specific particle size groups.

26. The apparatus of claim 25 including a mass analyzer measuring the mass of the particulate matter and resolving the resulting measured mass and particle counts to estimates of the mass of the particles according to size as defined by the size histogram.

27. The apparatus of claim 26 wherein said mass analyzer is adapted to be on a moving vehicle.

28. The apparatus of claim 26 wherein said mass analyzer is adapted to be separate from a vehicle.

29. An apparatus for characterizing particulate matter in gases emitted from the exhaust tailpipe of a moving vehicle, comprising:
a sampler for retrieving gases emitted from the exhaust tailpipe;
an ambient air mass flow controller adapted to be on a moving vehicle for supplying a controlled flow of ambient air;
a gas mass flow controller adapted to be on the moving vehicle for providing controlled flow of the gases retrieved from the exhaust tailpipe;
said controlled flow of gases mixed with the controlled flow of ambient air, thereby forming diluted samples of the gases containing volatile and non-volatile particulate matter; and
a particulate analyzer adapted to be on the moving vehicle, said particulate analyzer measuring at least one parameter of the particulate matter.

30. The apparatus of claim 29 wherein said ambient air mass flow controller and said gas mass flow controller adapted to be mounted in proximity to a vehicle tailpipe, enabling immediate mixing of the gases with the ambient air.

31. The apparatus of claim 29 wherein said sampler comprising a pipe linked to the exhaust tailpipe.

32. The apparatus of claim 31 wherein said linking line is heated in order to reduce loss of the particulate matter in said linking line.

33. The apparatus of claim 31 wherein said linking line is heated to temperatures within the range of 50 to 200 degrees centigrade.

34. The apparatus of claim 29 wherein at least one said ambient air mass flow controller and said gas mass flow controller provides adjustable levels of mass flow.

35. An apparatus for measuring and characterizing particulate matter emitted from an engine, comprising:
a mass analyzer for measuring the mass of the particulate matter;
a particle analyzer counting the particles present in the particulate matter by particular size histogram entailing specific particle size groups; and
a computer resolving the resulting measured mass and particle counts to estimates of the mass of said particles according to their size as defined by said size histogram.

36. A method of characterizing particulate matter in gases emitted from the exhaust tailpipe of a moving vehicle, comprising:
providing a micro-dilution device on the vehicle;
while the vehicle is moving retrieving samples of the gases and mixing said samples with ambient air with said micro-dilution device thereby forming diluted samples of the gases containing volatile and non-volatile particulate matter; and
providing a particulate analyzer on the vehicle;
retrieving a partial gas volume of said diluted samples and measuring at least one parameter of the volatile and non-volatile particulate matter with said particulate analyzer.

37. The method of claim 36 including controlling the flow of said ambient air with said micro-dilution device.

38. The method of claim 36 including controlling the flow of said gases with said micro-dilution device.

39. The method of claim 38 including controlling the flow of said ambient air with said micro-dilution device.

40. The method of claim 39 including adjustably controlling at least one chosen from ambient air mass flow and gas mass flow.

41. The method of claim 36 including positioning said micro-dilution device in proximity of a vehicle tailpipe, enabling immediate mixing of the gases with the ambient air.

42. The method of claim 36 including retrieving said samples through a linking line linked to the exhaust tailpipe.

43. The method of claim 42 including heating said linking line in order to reduce loss of the particulate matter in said linking line.

44. The method of claim 42 including heating said linking line to temperatures within the range of 50 to 200 degrees centigrade.

45. The method of claim 36 wherein said particulate analyzer is a particulate counter capable of assessing the number of particles in the gases.

46. The method of claim 36 wherein said particulate analyzer comprises at least one light source and at least one photodetector.

47. The method of claim 46 wherein said particulate light source is a laser.

48. The method of claim 46 wherein said light source is an ultraviolet lamp.

49. The method of claim 36 wherein said particulate analyzer comprises an electromagnetic wave generator and an acoustic detector.

50. The method of claim 36 wherein said particulate analyzer comprises a charging device providing electrical charge to said particles and an electrometer capable of measuring the charge of said particles after said particles are charged by said charging device.

51. The method of claim 36 wherein said particulate analyzer comprises a Condensation Nucleus Counter (CNC).

52. The method of claim 36 wherein said particulate analyzer comprises an Incandescent Particle Counter (IPC).

53. The method of claim 36 including measuring the mass of the particulate matter.

54. The method of claim 36 wherein said particulate analyzer comprises a vibrating substrate accumulating the particulate matter, wherein changes of vibrating parameters of said substrate are indicative of the mass change of said substrate due to the accumulation of the particulate matter.

55. The method of claim 54 wherein said parameter is the resonance frequency of said substrate.

56. The method of claim 54 wherein said parameter is the vibration amplitude of said substrate.

57. The method of claim 56 wherein said substrate chosen from at least one of a quartz and a paper filter.

58. The method of claim 36 wherein measuring at least one parameter includes counting the particles present in the particulate matter by particular size histogram entailing specific particle size groups.

59. The method of claim 58 including measuring the mass of the particulate matter and resolving the resulting measured mass and particle counts to estimates of the mass of the particles according to their size as defined by said size histogram.

60. The method of claim 59 wherein said counting, said sorting and said resolving are performed on a moving vehicle.

61. The method of claim 59 wherein said counting, said sorting and said resolving are performed separate from a vehicle.

62. A method for characterizing particulate matter in gases emitted from the exhaust tailpipe of a moving vehicle, comprising:
retrieving gases emitted from the exhaust tailpipe;
supplying a controlled flow of ambient air on the vehicle;
supplying controlled flow of the gases retrieved from the exhaust tailpipe on the vehicle;
mixing said controlled flow of gases with the controlled flow of ambient air, thereby forming diluted samples of the gases containing volatile and non-volatile particulate matter; and
providing a particulate analyzer adapted to be on the moving vehicle, said particulate analyzer measuring at least one parameter of the particulate matter.

63. The method of claim 62 including immediate mixing of the gases with the ambient air in proximity to the vehicle exhaust tailpipe.

64. The method of claim 62 wherein said retrieving includes providing a pipe linked to the exhaust tailpipe.

65. The method of claim 64 wherein said linking line is heated in order to reduce loss of the particulate matter in said linking line.

66. The method of claim 64 wherein said linking line is heated to temperatures within the range of 50 to 200 degrees centigrade.

67. The method of claim 62 including adjustably controlling at least one chosen from ambient air mass flow and gas mass flow.

68. Method for measuring and characterizing particulate matter emitted from an engine, comprising the steps of:
measuring the mass of the particulate matter;
counting the particles present in the particulate matter by particular size histogram entailing specific particle size groups; and
resolving the resulting measured mass and particle counts to estimates of the mass of said particles according to their size as defined by said size histogram.

69. The apparatus of claim 18 including a gas flow meter on the vehicle, wherein the mass of the particulate matter is measured at least in part with said gas flow meter.
